(19) United States
(12) Patent Application Publication
(10) Pub. No.: US 2018/0202619 A1
(43) Pub. Date: Jul. 19, 2018

(54) STRING OF CHRISTMAS LIGHTS WITH SOCKETS

(71) Applicant: Jordan Dedene, Oak Park, MI (US)

(72) Inventor: Jordan Dedene, Oak Park, MI (US)

(21) Appl. No.: 15/405,719

(22) Filed: Jan. 13, 2017

(51) Int. Cl. F21S 4/10; F21V 23/06; H01R 25/00; H01R 13/717

(52) U.S. Cl. CPC F21S 4/10; F21V 23/06; F21Y 2115/10; H01R 13/7175; H01R 25/003

(57) ABSTRACT

An electrically operable decorative device for decorating comprising a male electrical plug positioned at a first end of a light string electrical cable along with a plurality of light sockets and associated light bulbs distributed on said light string electrical cable. A female electrical receptacle is at a second end of said light string electrical cable with at least one inner female electrical receptacle communicatively coupled and distributed on said light string electrical cable.

### BACKGROUND OF THE INVENTION

### 1. Field of Invention

This invention relates to decorative lighting, in particular to decorative lighting for the Christmas season that has sockets spaced at convenient intervals.

### 2. Description of Prior Art

The use of Christmas lights is known in the prior art. More specifically, Christmas lights heretofore are devised and utilized for the purpose of decorating Christmas trees. Houses are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,057,976 to DuMong; U.S. Pat. No. 5,422,801 to Sangalli, Jr.; U.S. Pat. No. Des. 358,673 to Thompson; U.S. Pat. No. 5,141,192 to Adams; U.S. Pat. No. 5,024,406 to Ketcham; and U.S. Pat. No. 5,245,519 to Openiano.

While these devices fulfill their respective, particular objective, and requirements, the aforementioned patents do not describe a Christmas light arrangement having sockets at convenient intervals. For example, to permit the simulation of icicles on a house or to festoon an open staircase.

Therefore, it can be appreciated that there exists a continuing need for new and improved Christmas light arrangements which can be used for simulating the appearance of icicles on a house or to festoon an open staircase. In this regard, the present invention substantially fulfills this need.

### BRIEF DESCRIPTION OF THE DRAWINGS

FIG. 1 is an exemplary view of a string of lights illustrating a series of convenient sockets.

FIG. 2 is a schematic view of the string of lights illustrating the configurable sockets.

### DETAILED DESCRIPTION

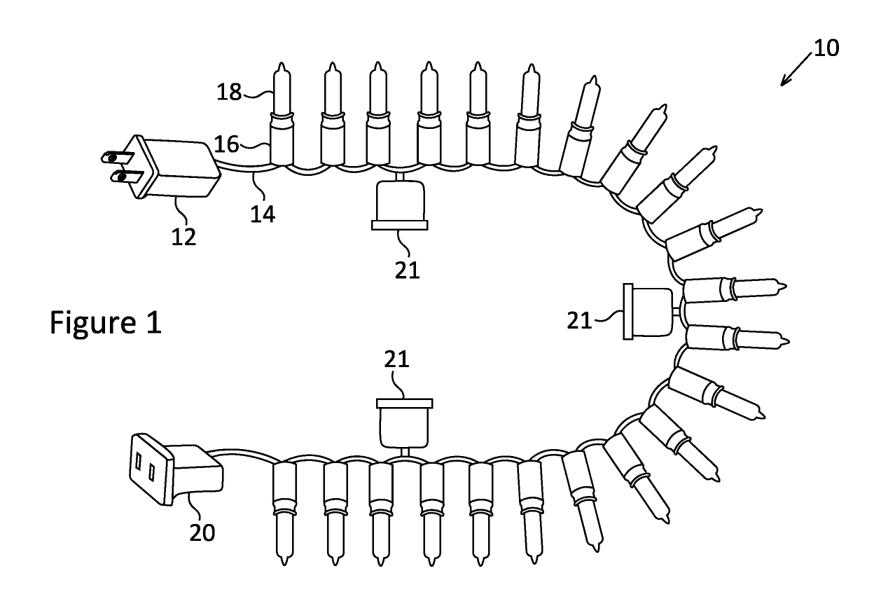

With reference to the Figures, wherein like numerals indicate like parts throughout the several views, FIG. 1 is an exemplary view of an electrically operable decorative device. A string of lights 10 with a male electrical plug 12 is communicatively coupled to a first end of a light string electrical cable 14. The plug 12 can be then plugged into a voltage source, for example, an outlet or an extension cord to power the string of lights 10. The cable 14 has a plurality of light sockets 16 and associated light bulbs 18 distributed on the cable 14. A female electrical receptacle 20 is positioned at a second end of the cable 14 to permit electricity to be available at the female electrical receptacle 20. This configuration also permits the daisychaining of the string of lights 10 and extensions cords. Additionally, an inner female electrical receptacle 21 is also communicatively coupled to the cable 14 permitting electricity to be available at the inner female electrical receptacle 21.

In an embodiment, the male electrical plug 12 is electrically polarized. For example, a wider prong on the polarized plug 12 will permit it to be plugged in only with the correct polarity. The narrower prong is the “hot” lead and a switch to an appliance is placed in that lead, guaranteeing that no voltage will reach the appliance when it is switched off. Additionally, the female electrical receptacle 20 and the inner female electrical receptacle 21 can also be electrically polarized.

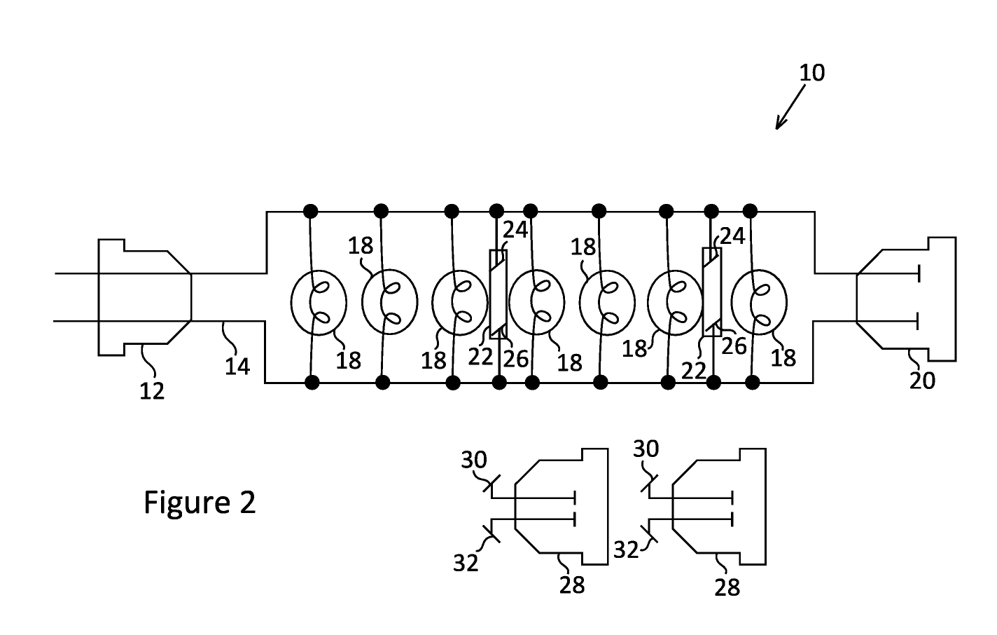

Now with reference to FIG. 2, which illustrates another embodiment. The light string electrical cable 14 may include an electrical tap 22 communicatively coupled to the light string electrical cable 14 anywhere between the plug 12 and the receptacle 20. Additionally, in another possible configuration, the receptacle 20 can be exchanged for the electrical tap 22.

An inner receptacle 28 can be inserted into the electrical tap 22, thereby permitting the user to configure where to place inner receptacle 28. A first prong 30 and a second prong 32 of the inner receptacle 28 are inserted into a first slot 24 and a second slot 26 of the electrical tap 22. The electrical tap 22 can also be electrically polarized like the plug 12 above.

In some embodiments, the associated light bulbs 18 can be an incandescent light bulb, a light emitting diode (LED) light bulb, and a florescent light bulb.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications, other than the examples provided would be apparent to those of skill in the art upon reading the above description. The scope of the invention should be determined, not with reference to the above description, but instead should be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. An electrically operable decorative device for decorating, the device comprising:
a male electrical plug positioned at a first end of a light string electrical cable;
a first series of light sockets, a second series of light sockets, and a third series of light sockets, each series of light sockets being distributed on said light string electrical cable, each light socket including an associated light socket body and an associated light bulb being received therein;
a female electrical receptacle at a second end of said light string electrical cable; and
a plurality of inner female electrical receptacle communicatively coupled and distributed on said light string electrical cable, each inner female electrical receptacle including an associated receptacle body, none of said receptacle bodies being in immediate contact with any of said light socket bodies,
wherein each of said plurality of inner female electrical receptacles is in an alternating arrangement with said first, second, and third series of light sockets.

2. The device according to claim 1, wherein said male electrical plug is electrically polarized.

3. The device according to claim 2, wherein said female electrical receptacle and said plurality of inner female electrical receptacles are electrically polarized.

4. The device according to claim 1, wherein said light string electrical cable includes an electrical tap distributed on said light string electrical cable.

5. The device according to claim 4, further includes an inner receptacle to plug into said electrical tap.

6. The device according to claim 5, wherein said electrical tap and said inner female receptacle are electrically polarized.

7. The device according to claim 1, wherein said associated light bulbs are selected from the group consisting of an incandescent light bulb, a light emitting diode (LED) light bulb, and a florescent light bulb.

8. A system for an electrically operable decorative device, the system comprising:
a male electrical plug positioned at a first end of a light string electrical cable to be plugged into a voltage source;
a first series of light sockets, a second series of light sockets, and a third series of light sockets, distributed on said light string electrical cable, each light socket including an associated light socket body and an associated light bulb being received therein;
a female electrical receptacle at a second end of said light string electrical cable, thereby permitting daisy chaining of said light string electrical cable; and
a plurality of electrical taps communicatively coupled and distributed on said light string electrical cable, each inner female electrical tap including an associated tap body, none of said tap bodies being in immediate contact with any of said light socket bodies,
wherein each of said plurality of electrical taps is in an alternating arrangement with said first, second, and third series of light sockets.

9. The system according to claim 8, wherein said male electrical plug is electrically polarized.

10. The system according to claim 9, wherein said female electrical receptacle is electrically polarized.

11. (canceled)

12. The system according to claim 8, further includes an inner receptacle to plug into an associated one of said plurality of electrical taps.

13. The system according to claim 12, wherein said plurality of electrical taps and said inner receptacle are electrically polarized.

14. The system according to claim 8, wherein said associated light bulbs are selected from the group consisting of of an incandescent light bulb, a light emitting diode (LED) light bulb, and a florescent light bulb.

15. A method for providing electricity along an electrically operable decorative device, the method comprising:
providing a light string electrical cable having a first series of light sockets, a second series of light sockets, and a third series of light sockets, each series of light sockets including an associated light socket body and an associated light bulb fitted therein, and a plurality of inner female electrical taps, each inner female electrical tap including an associated tap body, none of said tap bodies being in immediate contact with any of said light socket bodies, said plurality of electrical taps being in an alternating arrangement with said first, second, and third series of light sockets;
plugging a male electrical plug at a first end of a light string electrical cable into a voltage source; and
plugging another male electrical plug into a female electrical receptacle at a second end of said light string electrical cable.

16. The method according to claim 15, wherein said male electrical plug is electrically polarized.

17. The method according to claim 15, wherein said female electrical receptacle is electrically polarized.

18. The method according to claim 15, wherein the method further comprises:
providing an inner female electrical receptacle;
plugging said inner female receptacle into said electrical tap; making available the voltage source at said inner female receptacle.

19. The method according to claim 18, wherein said electrical tap and said inner female receptacle are electrically polarized.

20. The method according to claim 18, wherein a light bulb of said light string electrical cable are selected from the group consisting of an incandescent light bulb, a light emitting diode (LED) light bulb; and a florescent light bulb.
